(19) United States
(12) Patent Application Publication
(10) Pub. No.: US 2026/0230959 A1
(43) Pub. Date: Aug. 6, 2026

(54) METHOD FOR DETERMINING STARTING TIME, COMMUNICATION DEVICE, AND STORAGE MEDIUM

(71) Applicant: Beijing Xiaomi Mobile Software Co., Ltd., Beijing (CN)

(72) Inventors: Yanhua LI, Beijing (CN); Yumin WU, Beijing (CN)

(21) Appl. No.: 19/147,263

(22) PCT Filed: Jan. 12, 2023
(86) PCT No.: PCT/CN2023/071980

§ 371 Date: Jul. 10, 2025

(51) Int. Cl. H04W 36/00

(52) U.S. Cl. CPC H04W 36/00835; H04W 36/0072

(57) ABSTRACT

A method for determining a starting time of a secondary cell (SCell) deactivation timer, including: determining the starting time of the SCell deactivation timer based on a reference time and a time offset, where the reference time is determined based on a reception time for receiving a radio resource control (RRC) message, and the RRC message is configured to activate a SCell.

### CROSS-REFERENCE TO RELATED APPLICATIONS

The present application is a U.S. National Stage of International Application No. PCT/CN2023/071980, filed on Jan. 12, 2023, the contents of all of which are incorporated herein by reference in their entirety for all purposes.

### BACKGROUND OF THE INVENTION

A plurality of methods for activating a secondary cell (SCell) are included in a wireless communication system.

### SUMMARY OF THE INVENTION

The present disclosure relates to, but is not limited to, the technical field of wireless communication, and in particular to a method for determining a starting time of a secondary cell (SCell) deactivation timer, a communication device, and a storage medium.

Embodiments of the present disclosure disclose a method for determining a starting time of a secondary cell (SCell) deactivation timer, a communication device, and a storage medium.

According to a first aspect of the embodiments of the present disclosure, a method for determining a starting time of a secondary cell (SCell) deactivation timer is provided. The method is performed by a terminal and includes:
determining the starting time of the SCell deactivation timer based on a reference time and a time offset,
where the reference time is determined based on a reception time for receiving a radio resource control (RRC) message, and the RRC message is configured to activate a SCell.

According to a second aspect of the embodiments of the present disclosure, a communication device is provided. The communication device includes:
one or more processors; and
a memory configured to store processor-executable instructions;
where the processor-executable instructions, when collectively executed by the one or more processors, cause the communication device to:
determine a starting time of a secondary cell (SCell) deactivation timer based on a reference time and a time offset,
where the reference time is determined based on a reception time for receiving a radio resource control (RRC) message, and the RRC message is configured to activate a SCell

According to a third aspect of the embodiments of the present disclosure, a non-transitory computer storage medium is provided. The non-transitory computer storage medium stores a computer-executable instructions, where the computer-executable instructions, when executed by a processor, cause the non-transitory computer storage medium to:
determine a starting time of a secondary cell (SCell) deactivation timer based on a reference time and a time offset,
where the reference time is determined based on a reception time for receiving a radio resource control (RRC) message, and the RRC message is configured to activate a SCell.

### BRIEF DESCRIPTION OF DRAWINGS

FIG. 1 is a schematic structural diagram of a wireless communication system according to an example.

FIG. 2 is a schematic flowchart of a method for determining a starting time of a secondary cell (SCell) deactivation timer according to an example.

FIG. 3 is a schematic flowchart of a method for determining the starting time of the SCell deactivation timer according to an example.

FIG. 4 is a schematic flowchart of a method for determining the starting time of the SCell deactivation timer according to an example.

FIG. 5 is a schematic flowchart of a method for determining the starting time of the SCell deactivation timer according to an example.

FIG. 6 is a schematic diagram of a device for determining the starting time of the SCell deactivation timer according to an example.

FIG. 7 is a schematic structural diagram of a terminal according to an example.

FIG. 8 is a block diagram of a base station according to an example.

### DETAILED DESCRIPTION OF THE INVENTION

Examples are described in detail herein, with examples shown in the accompanying drawings. In a case where the following description involves the accompanying drawings, unless otherwise indicated, the same numerals in different accompanying drawings represent the same or similar elements. Implementations described in the following examples do not represent all implementations consistent to the embodiments of the present disclosure. On the contrary, they are merely examples of devices and methods consistent to some aspects of the embodiments of the present disclosure described in detail in the appended claims.

The terms used in the embodiments of the present disclosure are merely used for the purpose of describing specific embodiments and are not intended to limit the embodiments of the present disclosure. Singular forms including “a/an” and “the” used in the embodiments of the present disclosure and the appended claims are also intended to include plural forms, unless the context clearly indicates otherwise. It is also to be understood that the term “and/or” used herein refers to and includes any or all possible combinations of one or more of associated listed items.

It is to be understood that although the terms such as first, second, and third may be used to describe various types of information in the embodiments of the present disclosure, such information may not be limited to these terms. These terms are merely used to distinguish between similar types of information. For example, without departing from the scope of the embodiments of the present application, first information may also be referred to as second information, and similarly, second information may also be referred to as first information. The word “if” as used herein may be interpreted as “in a case where” or “upon” or “in response to determining”, depending on the context.

For the sake of brevity and ease of understanding, the terms “greater than” or “smaller than” are used herein to represent a magnitude relationship. However, it is appreciated by those skilled in the art that the term “greater than” also encompasses the meaning of “greater than or equal to”, and the term “smaller than” also encompasses the meaning of “smaller than or equal to”.

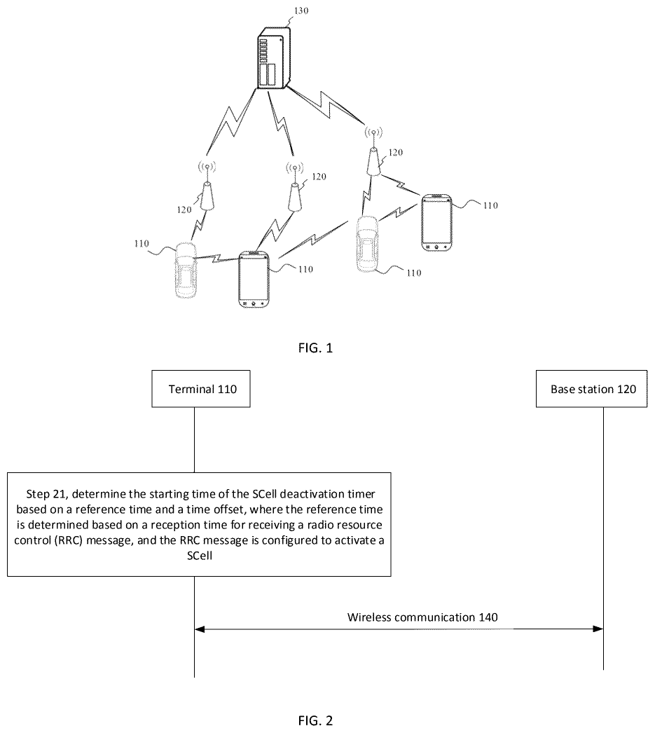

Refer to FIG. 1, a schematic structural diagram of a wireless communication system according to an embodiment of the present disclosure is illustrated. As shown in FIG. 1, the wireless communication system is a communication system based on a mobile communication technology. The wireless communication system may include: a plurality of user equipments 110 and a plurality of base stations 120.

A user equipment 110 may be a device that provides at least one of voice or data connectivity to a user. The user equipment 110 may communicate with one or more core networks via a radio access network (RAN). The user equipment 110 may be an Internet of Things user equipment, such as a sensor device, a mobile phone, and a computer with the Internet of Things user equipment. For example, the user equipment may be a fixed, portable, pocket-sized, handheld, computer-embedded, or vehicle-mounted device, such as a station (STA), a subscriber unit, a subscriber station, a mobile station, a mobile, a remote station, an access point, a remote terminal, an access terminal, a user terminal, a user agent, a user device, or user equipment. Alternatively, the user equipment 110 may also be a device of an unmanned aerial vehicle. Alternatively, the user equipment 110 may also be the vehicle-mounted device, such as an on-board computer with a wireless communication function or a wireless user device externally connected to an on-board computer. Alternatively, the user equipment 110 may also be a road side device, such as a street lamp, a traffic light, or other road side devices with a wireless communication function.

A base station 120 may be a network-side device in the wireless communication system. The wireless communication system may be a 4th generation mobile communication technology (4G) system, also referred to as a long-term evolution (LTE) system. Alternatively, the wireless communication system may also be a 5G system, also referred to as a new radio system or a 5G NR system. Alternatively, the wireless communication system may also be a next-generation system beyond the 5G system. An access network in the 5G system may be referred to as a new generation radio access network (NG-RAN).

The base station 120 may be an evolved node B (eNB) used in the 4G system. Alternatively, the base station 120 may also be a base station (gNB) using a centralized-distributed architecture in the 5G system. In a case where the base station uses the centralized-distributed architecture, the base station 120 typically includes a central unit (CU) and at least two distributed units (DUs). The central unit is equipped with protocol stacks for a packet data convergence protocol (PDCP) layer, a radio link control (RLC) layer, and a media access control (MAC) layer, and the distributed unit is equipped with a protocol stack for a physical (PHY) layer. The specific implementation of the base station 120 is not limited to the embodiments of the present disclosure.

A wireless connection may be established between the base station 120 and the user equipment 110 via a wireless air interface. In different implementations, the wireless air interface is a wireless air interface based on the 4th generation mobile communication network technology (4G) standard. Alternatively, the wireless air interface is a wireless air interface based on the 5th generation mobile communication network technology (5G) standard. For example, the wireless air interface is new radio, or the wireless air interface may also be a wireless air interface based on the next-generation mobile communication network technology standard beyond 5G.

In some embodiments, an end-to-end (E2E) connection may also be established between the user equipments 110, for example, in scenarios such as a vehicle to vehicle (V2V) communication, a vehicle to infrastructure (V2I) communication, and a vehicle to pedestrian (V2P) communication in vehicle to everything (V2X) communications.

Here, the above-mentioned user equipment may be considered as a terminal device in the following embodiments.

In some embodiments, the above-mentioned wireless communication system may also include a network management device 130.

The plurality of base stations 120 are respectively connected to the network management device 130. The network management device 130 may be a core network device in the wireless communication system. For example, the network management device 130 may be a mobility management entity (MME) in an evolved packet core (EPC). Alternatively, the network management device may also be other core network devices, such as a serving gateway (SGW), a public data network gateway (PGW), a policy and charging rules function (PCRF), or a home subscriber server (HSS). The implementation form of the network management device 130 is not limited to the embodiments of the present disclosure.

To facilitate understanding by those skilled in the art, a plurality of implementations are provided in the embodiments of the present disclosure to clearly illustrate the technical solutions described in the embodiments of the present disclosure. Naturally, those skilled in the art may understand that the plurality of embodiments provided in the embodiments of the present disclosure may be performed independently, or may be performed together in conjunction with methods in other embodiments of the present disclosure, or may be performed independently or in conjunction with some methods in other related art, which is not limited to the embodiments of the present disclosure.

The related art includes a plurality of methods for activating a secondary cell (SCell). For example, one method may involve activating the SCell directly via a radio resource control (RRC) message, where the RRC message carries information that indicates a cell state is activated. For another example, the other method may involve activating the SCell by activating a medium access control control element (MAC CE) of a cell. A SCell inactivity timer needs to be started or restarted. However, for the first method mentioned above, there is no mechanism to determine a starting time or a restarting time of the SCell inactivity timer.

As shown in FIG. 2, the embodiment provides a method for determining a starting time of the SCell deactivation timer. The method is performed by a terminal and includes:

Step 21: determine the starting time of the SCell deactivation timer based on a reference time and a time offset.

The reference time is determined based on a reception time for receiving a radio resource control (RRC) message, and the RRC message is configured to activate a SCell.

Here, the terminal involved in the present disclosure may include, but is not limited to, at least one of: a mobile phone, a wearable device, a vehicle-mounted terminal, a road side unit (RSU), a smart home terminal, an industrial sensor device or a medical device. In some embodiments, the terminal may be a redcap terminal or a new radio (NR) terminal of a preset version (e.g., a NR terminal for release 17 (R17)).

The base stations involved in the present disclosure may be various types of base stations, such as a base station of a 3rd generation mobile communication (3G) network, a base station of a 4th generation mobile communication (4G) network, a base station of a 5th generation mobile communication (5G) network, or other evolved base stations.

In one embodiment, the starting time for starting or restarting the SCell deactivation timer is determined based on the reference time and the time offset, where the reference time is determined based on the reception time for receiving the RRC message, and the RRC message is configured to activate the SCell.

In one embodiment, the starting time of the SCell deactivation timer is determined based on the reference time and the time offset, where the reference time includes a slot (slot n) for receiving the RRC message, and the RRC message is configured to activate the SCell.

In one embodiment, the slot n is the last slot for receiving physical downlink shared channel (PDSCH) transmission carrying the RRC message.

In one embodiment, the slot for receiving the RRC message is the last slot for the terminal to receive the RRC message.

In one embodiment, the starting time of the SCell deactivation timer is determined based on the reference time and the time offset determined based on a predefined communication protocol, where the reference time is determined based on the reception time for receiving the RRC message, and the RRC message is configured to activate the SCell.

In one embodiment, the starting time of the SCell deactivation timer is determined based on the reference time and the time offset determined based on configuration information sent by the base station, where the reference time is determined based on the reception time for receiving the RRC message, and the RRC message is configured to activate the SCell.

In one embodiment, the starting time of the SCell deactivation timer is determined based on the reference time and the time offset determined based on configuration information configured by a user, where the reference time is determined based on the reception time for receiving the RRC message, and the RRC message is configured to activate the SCell.

In one embodiment, the starting time of the SCell deactivation timer is determined based on the reference time and the time offset determined based on information locally stored in the terminal, where the reference time is determined based on the reception time for receiving the RRC message, and the RRC message is configured to activate the SCell.

In one embodiment, the starting time of the SCell deactivation timer is determined based on the reference time and the time offset, where the reference time is determined based on reception time for receiving an RRC connection reconfiguration message during a SCell addition procedure (at Scell addition), and the RRC message is configured to activate the SCell.

In one embodiment, the starting time of the SCell deactivation timer is determined based on the reference time and the time offset, where the reference time is determined based on reception time for receiving an RRC handover message during a cell handover procedure (at Handover), and the RRC message is configured to activate the SCell.

In one embodiment, the starting time of the SCell deactivation timer is determined based on the reference time and the time offset, where the reference time is determined based on reception time for receiving an RRC connection resume message during an RRC connection resume procedure (at RRC resume), and the RRC message is configured to activate the SCell.

In one embodiment, the starting time of the SCell deactivation timer is determined based on the reference time and the time offset, where the reference time is determined based on the reception time for receiving the RRC message, and the RRC message is configured to activate the SCell; and the time offset is determined based on a processing time for processing the RRC message.

In one embodiment, the time offset is determined based on the processing time for processing the RRC message. The starting time of the SCell deactivation timer is determined based on the reference time and the time offset, where the reference time is determined based on the reception time for receiving the RRC message, and the RRC message is configured to activate the SCell.

In one embodiment, in a case where the RRC message is the RRC connection reconfiguration message or the RRC connection resume message, the processing for the RRC message includes at least one of the following:
receiving the RRC message; or
sending a response message of the RRC message to an access network device.

In one embodiment, the time offset is determined based on a processing time for processing the RRC message. In a case where the RRC message is the RRC connection reconfiguration message or the RRC connection resume message, the processing time includes: a first processing duration, where the first processing duration is a processing delay for receiving the RRC message; and a second processing duration, where the second processing duration is a duration from receiving the RRC message to sending the response message of the RRC message to the access network device. The starting time of the SCell deactivation timer is determined based on the reference time and the time offset, where the reference time is determined based on the reception time for receiving the RRC message, and the RRC message is configured to activate the SCell.

For example, the second processing duration may be a duration from time X until sending the response message of the RRC message, where X=slot n+T_{RRC_Process}/NR slot length, slot n is a slot for receiving the RRC message, T_{RRC_Process} is a duration for processing the received RRC message, and NR slot length is a slot duration for NR. In one embodiment, the reception in the example may correspond to a point in time that data decoding is completed.

In one embodiment, the response message may be an RRC connection reconfiguration complete message, in a case where the RRC message is the RRC connection reconfiguration message.

In one embodiment, the response message may be an RRC connection resume complete message, in a case where the RRC message is the RRC connection resume message.

In one embodiment, in a case where the RRC message is the RRC handover message, the processing for the RRC message includes at least one of the following:
a processing for the received RRC message;
a processing for switching a terminal; or
a processing for a timing advance (TA).

In one embodiment, the time offset is determined based on the processing time for processing the RRC message. In a case where the RRC message is the RRC handover message, the processing time includes: a first processing duration, where the first processing duration is a processing delay for receiving the RRC message; a third processing duration, where the third processing duration is a handover interruption duration; and a fourth processing duration, where the fourth processing duration is a duration for processing the TA, where the duration for processing the TA includes: a duration from the end of the handover interruption duration to the reception of a valid TA command and a duration for applying the TA. The starting time of the SCell deactivation timer is determined based on the reference time and the time offset, where the reference time is determined based on the reception time for receiving the RRC message, and the RRC message is configured to activate the SCell.

For example, the duration from the end of the handover interruption duration to the reception of the valid TA command may be a duration from time Y until receiving the valid TA command, where Y=slot n+(T_{RRC_Process}+Tᵢₙₜₑᵣᵣᵤₚₜ)/_{NR slot length}, slot n is a slot for receiving the RRC message, T_{RRC_Process} is a duration for processing the received RRC message, and NR slot length is a slot duration for NR. It is to be noted that the corresponding duration and time in the example are represented by slots.

In one embodiment, the time offset is determined based on the processing time for processing the RRC message. In a case where the RRC message is the RRC connection reconfiguration message or the RRC connection resume message, the processing time includes: a first processing duration, where the first processing duration is a processing delay for receiving the RRC message; a second processing duration, where the second processing duration is a duration from receiving the RRC message to sending the response message of the RRC message to the access network device; and a fifth processing duration, where the fifth processing duration is a preset duration. For example, the fifth processing duration is a duration determined based on a predefined communication protocol. The starting time of the SCell deactivation timer is determined based on the reference time and the time offset, where the reference time is determined based on reception time for receiving the RRC message, and the RRC message is configured to activate the SCell.

In one embodiment, the time offset is determined based on the processing time for processing the RRC message. In a case where the RRC message is the RRC handover message, the processing time includes: the first processing duration, where the first processing duration is the processing delay for receiving the RRC message; the third processing duration, where the third processing duration is the handover interruption duration; the fourth processing duration, where the fourth processing duration is the duration for processing the TA, where the duration for processing the TA includes: the duration from the end of the handover interruption duration to the reception of the valid TA command and the duration for applying the TA; and the fifth processing duration, where the fifth processing duration is the preset duration. For example, the fifth processing duration is the duration determined based on the predefined communication protocol. The starting time of the SCell deactivation timer is determined based on the reference time and the time offset, where the reference time is determined based on the reception time for receiving the RRC message, and the RRC message is configured to activate the SCell.

In one embodiment, the time offset is determined based on the processing time for processing the RRC message. The processing time is time determined based on the slot. The starting time of the SCell deactivation timer is determined based on the reference time and the time offset, where the reference time is determined based on the reception time for receiving the RRC message, and the RRC message is configured to activate the SCell.

In the embodiment of the present disclosure, the starting time of the SCell deactivation timer is determined based on the reference time and the time offset, where the reference time is determined based on the reception time for receiving the RRC message, and the RRC message is configured to activate the SCell. Here, the starting time of the SCell deactivation timer may be explicitly determined based on the reception time for receiving the RRC message configured to activate the SCell and the time offset. Compared with a case where the starting time of the SCell deactivation timer is uncertain, the SCell deactivation timer may be started promptly, and an operation in a scenario where the SCell deactivation timer is started may be performed promptly. In this way, wireless communication may be more reliable.

It is to be noted that, those skilled in the art may understand that the methods provided in the embodiments of the present disclosure may be performed independently, or may be performed together in conjunction with some methods in the embodiments of the present disclosure or some methods in the related art.

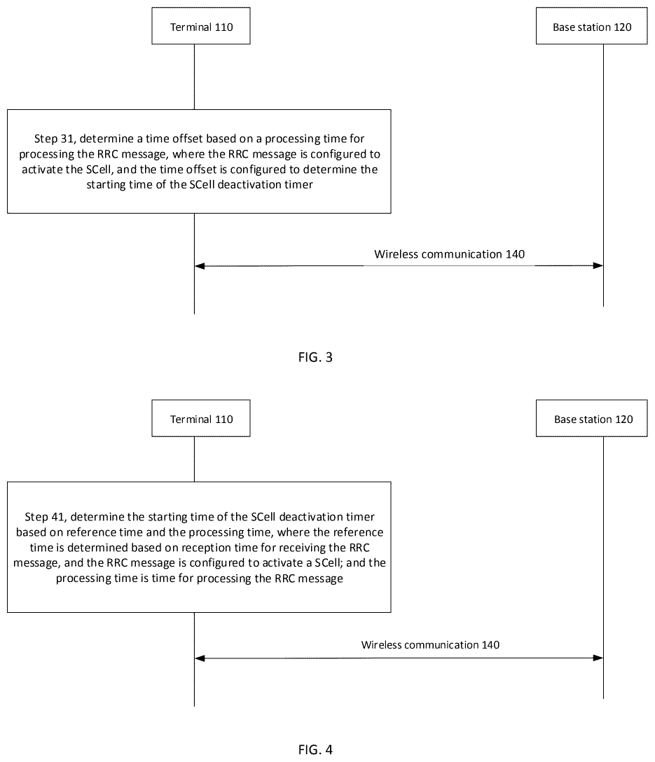

As shown in FIG. 3, a method for determining the starting time of the SCell deactivation timer is provided in the embodiment. The method is performed by a terminal and includes:

Step 31: determine the time offset based on the processing time for processing the RRC message.

The RRC message is configured to activate the SCell, and the time offset is configured to determine the starting time of the SCell deactivation timer.

In one embodiment, the time offset is determined based on the processing time for processing the RRC message. The starting time of the SCell deactivation timer is determined based on the reference time and the time offset, where the reference time is determined based on the reception time for receiving the RRC message, and the RRC message is configured to activate the SCell.

In one embodiment, the time offset is determined based on the processing time for processing the RRC message. In a case where the RRC message is the RRC connection reconfiguration message or the RRC connection resume message, the processing time includes: the first processing duration, where the first processing duration is the processing delay for receiving the RRC message; and the second processing duration, where the second processing duration is the duration from receiving the RRC message to sending the response message of the RRC message to an access network device. The starting time of the SCell deactivation timer is determined based on the reference time and the time offset, where the reference time is determined based on the reception time for receiving the RRC message, and the RRC message is configured to activate the SCell.

In one embodiment, the time offset is determined based on the processing time for processing the RRC message. In a case where the RRC message is the RRC handover message, the processing time includes: the first processing duration, where the first processing duration is the processing delay for receiving the RRC message; the third processing duration, where the third processing duration is the handover interruption duration; and the fourth processing duration, where the fourth processing duration is the duration for processing the TA, where the duration for processing the TA includes: the duration from the end of the handover interruption duration to the reception of the valid TA command and the duration for applying the TA. The starting time of the SCell deactivation timer is determined based on the reference time and the time offset, where the reference time is determined based on the reception time for receiving the RRC message, and the RRC message is configured to activate the SCell.

In one embodiment, the time offset is determined based on the processing time for processing the RRC message. In a case where the RRC message is the RRC connection reconfiguration message or the RRC connection resume message, the processing time includes: the first processing duration, where the first processing duration is the processing delay for receiving the RRC message; the second processing duration, where the second processing duration is the duration from receiving the RRC message to sending the response message of the RRC message to the access network device; and the fifth processing duration, where the fifth processing duration is the preset duration. For example, the fifth processing duration is the duration determined based on the predefined communication protocol. The starting time of the SCell deactivation timer is determined based on the reference time and the time offset, where the reference time is determined based on the reception time for receiving the RRC message, and the RRC message is configured to activate the SCell.

In one embodiment, the time offset is determined based on the processing time for processing the RRC message. In a case where the RRC message is the RRC handover message, the processing time includes: the first processing duration, where the first processing duration is the processing delay for receiving the RRC message; the third processing duration, where the third processing duration is the handover interruption duration; the fourth processing duration, where the fourth processing duration is the duration for processing the TA, where the duration for processing the TA includes: the duration from the end of the handover interruption duration to the reception of the valid TA command and the duration for applying the TA; and the fifth processing duration, where the fifth processing duration is the preset duration. For example, the fifth processing duration is the duration determined based on the predefined communication protocol. The starting time of the SCell deactivation timer is determined based on the reference time and the time offset, where the reference time is determined based on the reception time for receiving the RRC message, and the RRC message is configured to activate the SCell.

It is to be noted that those skilled in the art may understand that the methods provided in the embodiments of the present disclosure may be performed independently, or may be performed together in conjunction with some methods in the embodiments of the present disclosure or some methods in the related art.

As shown in FIG. 4, a method for determining the starting time of the SCell deactivation timer is provided in the embodiment. The method is performed by the terminal and includes:

Step 41: determine the starting time of the SCell deactivation timer based on the reference time and the processing time.

The reference time is determined based on the reception time for receiving the RRC message, and the RRC message is configured to activate the SCell; and the processing time is time for processing the RRC message.

In one embodiment, the starting time of the SCell deactivation timer is determined based on the reference time and the processing time, where the reference time is determined based on the reception time for receiving the RRC message, and the RRC message is configured to activate the SCell; and the processing time is time for processing the RRC message. In a case where the RRC message is the RRC connection reconfiguration message, the processing time includes: the first processing duration, where the first processing duration is the processing delay for receiving the RRC message; and the second processing duration, where the second processing duration is the duration from receiving the RRC message to sending the response message of the RRC message to the access network device.

In one embodiment, the starting time of the SCell deactivation timer is determined based on the reference time and the processing time, where the reference time is determined based on the reception time for receiving the RRC message, and the RRC message is configured to activate the SCell; and the processing time is the time for processing the RRC message. In a case where the RRC message is the RRC connection resume message, the processing time includes: the first processing duration, where the first processing duration is the processing delay for receiving the RRC message; and the second processing duration, where the second processing duration is the duration from receiving the RRC message to sending the response message of the RRC message to the access network device.

In one embodiment, the starting time of the SCell deactivation timer is determined based on the reference time and the processing time, where the reference time is determined based on the reception time for receiving the RRC message, and the RRC message is configured to activate the SCell; and the processing time is time for processing the RRC message. In a case where the RRC message is the RRC handover message, the processing time includes: the first processing duration, where the first processing duration is the processing delay for receiving the RRC message; the third processing duration, where the third processing duration is the handover interruption duration; the fourth processing duration, where the fourth processing duration is the duration for processing the TA, and the duration for processing the TA includes: the duration from the end of the handover interruption duration to the reception of the valid TA command and the duration for applying the TA; and the fifth processing duration, where the fifth processing duration is determined based on the predefined communication protocol.

In one embodiment, the starting time of the SCell deactivation timer is determined based on the reference time and the processing time, where the reference time is determined based on the reception time for receiving the RRC message, and the RRC message is configured to activate the SCell; and the processing time is the time for processing the RRC message. In a case where the RRC message is the RRC connection reconfiguration message, the processing time includes: the first processing duration, where the first processing duration is the processing delay for receiving the RRC message; and the second processing duration, where the second processing duration is the duration from receiving the RRC message to sending the response message of the RRC message to the access network device.

In one embodiment, the starting time of the SCell deactivation timer is determined based on the reference time and the processing time, where the reference time is determined based on the reception time for receiving the RRC message, and the RRC message is configured to activate the SCell; and the processing time is the time for processing the RRC message. In a case where the RRC message is the RRC connection resume message, the processing time includes: the first processing duration, where the first processing duration is the processing delay for receiving the RRC message; the second processing duration, where the second processing duration is the duration from receiving the RRC message to sending the response message of the RRC message to the access network device; and the fifth processing duration, where the fifth processing duration is determined based on the predefined communication protocol.

In one embodiment, the starting time of the SCell deactivation timer is determined based on the reference time and the processing time, where the reference time is determined based on the reception time for receiving the RRC message, and the RRC message is configured to activate the SCell; and the processing time is the time for processing the RRC message. In a case where the RRC message is the RRC handover message, the processing time includes: the first processing duration, where the first processing duration is the processing delay for receiving the RRC message; the third processing duration, where the third processing duration is the handover interruption duration; the fourth processing duration, where the fourth processing duration is the duration for processing the TA, where the duration for processing the TA includes: the duration from the end of the handover interruption duration to the reception of the valid TA command and the duration for applying the TA; and the fifth processing duration, where the fifth processing duration is determined based on the predefined communication protocol.

The communication method between terminal 110 and base station 120 in FIGS. 2 to 4 is wireless communication 140.

It is to be noted that, those skilled in the art may understand that the methods provided in the embodiments of the present disclosure may be performed independently, or may be performed together in conjunction with some methods in the embodiments of the present disclosure or some methods in the related art.

As shown in FIG. 5, the embodiment provides a method for determining the starting time of the SCell deactivation timer. The method is performed by the terminal and includes:

Step 51: determine the starting time of the SCell deactivation timer based on the reference time.

The reference time is determined based on the reception time for receiving the RRC message, and the RRC message is configured to activate a SCell.

Here, the terminal involved in the present disclosure may include, but is not limited to, at least one of: the mobile phone, the wearable device, the vehicle-mounted terminal, the RSU, the smart home terminal, the industrial sensor device or the medical device. In some embodiments, the terminal may be the redcap terminal or the new radio (NR) terminal of the preset version (e.g., the NR terminal for R17).

The base stations involved in the present disclosure may be various types of base stations, such as the base station of the 3rd generation mobile communication (3G) network, the base station of the 4th generation mobile communication (4G) network, the base station of the 5th generation mobile communication (5G) network, or other evolved base stations.

In one embodiment, the starting time of the SCell deactivation timer is determined based on the reference time, where the reference time is determined based on reception time of the RRC connection reconfiguration message received during a SCell addition procedure (at SCell addition), and the RRC message is configured to activate the SCell.

In one embodiment, the starting time of the SCell deactivation timer is determined based on the reference time, where the reference time is determined based on reception time of the RRC handover message received during a cell handover procedure (at handover), and the RRC message is configured to activate the SCell.

In one embodiment, the starting time of the SCell deactivation timer is determined based on the reference time, where the reference time is determined based on reception time of the RRC connection resume message received during an RRC connection resume procedure (at RRC resume), and the RRC message is configured to activate the SCell.

In one embodiment, the starting time for starting or restarting the SCell deactivation timer is determined based on the reference time, where the reference time is determined based on the reception time for receiving the RRC message, and the RRC message is configured to activate the SCell.

In one embodiment, the starting time of the SCell deactivation timer is determined based on the reference time and the time offset, where the reference time includes a slot for receiving the RRC message, and the RRC message is configured to activate the SCell.

In one embodiment, the starting time of the SCell deactivation timer is determined based on the reference time and the time offset determined based on the predefined communication protocol, where the reference time is determined based on the reception time for receiving the RRC message, and the RRC message is configured to activate the SCell.

In one embodiment, the starting time of the SCell deactivation timer is determined based on the reference time and the time offset determined based on the configuration information sent by the base station, where the reference time is determined based on the reception time for receiving the RRC message, and the RRC message is configured to activate the SCell.

In one embodiment, the starting time of the SCell deactivation timer is determined based on the reference time and the time offset determined based on configuration information configured by a user, where the reference time is determined based on the reception time for receiving the RRC message, and the RRC message is configured to activate the SCell.

In one embodiment, the starting time of the SCell deactivation timer is determined based on the reference time and the time offset determined based on information locally stored in the terminal, where the reference time is determined based on the reception time for receiving the RRC message, and the RRC message is configured to activate the SCell.

In one embodiment, the starting time of the SCell deactivation timer is determined based on the reference time and the time offset, where the reference time is determined based on the reception time of the RRC connection reconfiguration message received during the SCell addition procedure (at Scell addition), and the RRC message is configured to activate the SCell.

In one embodiment, the starting time of the SCell deactivation timer is determined based on the reference time and the time offset, where the reference time is determined based on the reception time of the RRC handover message received during the cell handover procedure (at Handover), and the RRC message is configured to activate the SCell.

In one embodiment, the starting time of the SCell deactivation timer is determined based on the reference time and the time offset, where the reference time is determined based on the reception time of the RRC connection resume message received during the RRC connection resume procedure (at RRC resume), and the RRC message is configured to activate the SCell.

In one embodiment, the starting time of the SCell deactivation timer is determined based on the reference time and the time offset, where the reference time is determined based on the reception time for receiving the RRC message, and the RRC message is configured to activate the SCell; and the time offset is determined based on the processing time for processing the RRC message.

In one embodiment, the time offset is determined based on the processing time for processing the RRC message. The starting time of the SCell deactivation timer is determined based on the reference time and the time offset, where the reference time is determined based on the reception time for receiving the RRC message, and the RRC message is configured to activate the SCell.

In one embodiment, in a case where the RRC message is the RRC connection reconfiguration message or the RRC connection resume message, the processing of the RRC message includes at least one of the following:
receiving the RRC message; or
sending the response message of the RRC message to the access network device.

In one embodiment, the time offset is determined based on the processing time for processing the RRC message. In a case where the RRC message is the RRC connection reconfiguration message or the RRC connection resume message, the processing time includes: the first processing duration, where the first processing duration is the processing delay for receiving the RRC message; and the second processing duration, where the second processing duration is the duration from receiving the RRC message to sending the response message of the RRC message to the access network device. The starting time of the SCell deactivation timer is determined based on the reference time and the time offset, where the reference time is determined based on the reception time for receiving the RRC message, and the RRC message is configured to activate the SCell.

For example, the second processing duration may be the duration from time X until sending the response message of the RRC message, where X=slot n+T_{RRC_Process}/NR slot length, slot n is the slot for receiving the RRC message, T_{RRC_Process} is the duration for processing the received RRC message, and the NR slot length is a slot duration for NR.

In one embodiment, the response message may be the RRC connection reconfiguration complete message, in a case where the RRC message is the RRC connection reconfiguration message.

In one embodiment, the response message may be the RRC connection resume complete message, in a case where the RRC message is the RRC connection resume message.

In one embodiment, in a case where the RRC message is the RRC handover message, the processing for the RRC message includes at least one of the following:
the processing for the received RRC message;
the processing for switching the terminal; or
the processing for the TA.

In one embodiment, the time offset is determined based on the processing time for processing the RRC message. In a case where the RRC message is the RRC handover message, the processing time includes: the first processing duration, where the first processing duration is the processing delay for receiving the RRC message; the third processing duration, where the third processing duration is the handover interruption duration; and the fourth processing duration, where the fourth processing duration is the duration for processing the TA, where the duration for processing the TA includes: the duration from the end of the handover interruption duration to the reception of the valid TA command and the duration for applying the TA. The starting time of the SCell deactivation timer is determined based on the reference time and the time offset, where the reference time is determined based on the reception time for receiving the RRC message, and the RRC message is configured to activate the SCell.

For example, the duration from the end of the handover interruption duration to the reception of the valid TA command may be the duration from time Y until receiving the valid TA command, where Y=slot n+(T_{RRC_Process}+Tᵢₙₜₑᵣᵣᵤₚₜ)/NR slot length, slot n is the slot for receiving the RRC message, T_{RRC_Process} is the duration for processing the received RRC message, and NR slot length is a slot duration for NR.

In one embodiment, the time offset is determined based on the processing time for processing the RRC message. In a case where the RRC message is the RRC connection reconfiguration message or the RRC connection resume message, the processing time includes: the first processing duration, where the first processing duration is the processing delay for receiving the RRC message; the second processing duration, where the second processing duration is the duration from receiving the RRC message to sending the response message of the RRC message to the access network device; and the fifth processing duration, where the fifth processing duration is the preset duration. For example, the fifth processing duration is the duration determined based on the predefined communication protocol. The starting time of the SCell deactivation timer is determined based on the reference time and the time offset, where the reference time is determined based on the reception time for receiving the RRC message, and the RRC message is configured to activate the SCell.

In one embodiment, the time offset is determined based on the processing time for processing the RRC message. In a case where the RRC message is the RRC handover message, the processing time includes: the first processing duration, where the first processing duration is the processing delay for receiving the RRC message; the third processing duration, where the third processing duration is the handover interruption duration; the fourth processing duration, where the fourth processing duration is the duration for processing TA, where the duration for processing the TA includes: the duration from the end of the handover interruption duration to the reception of the valid TA command and the duration for applying the TA; and the fifth processing duration, where the fifth processing duration is the preset duration. For example, the fifth processing duration is the duration determined based on the predefined communication protocol. The starting time of the SCell deactivation timer is determined based on the reference time and the time offset, where the reference time is determined based on the reception time for receiving the RRC message, and the RRC message is configured to activate the SCell.

In one embodiment, the time offset is determined based on the processing time for processing the RRC message. The processing time is the time determined based on the slot. The starting time of the SCell deactivation timer is determined based on the reference time and the time offset, where the reference time is determined based on the reception time for receiving the RRC message, and the RRC message is configured to activate the SCell.

It is to be noted that, those skilled in the art may understand that the methods provided in the embodiments of the present disclosure may be performed independently, or may be performed together in conjunction with some methods in the embodiments of the present disclosure or some methods in the related art.

For a better understanding of the embodiments of the present disclosure, the technical solutions of the present disclosure are further described through an example:

In one embodiment, for a direct SCell activation method, the starting time of the SCell inactivity timer is determined by adding one offset value (a first offset value corresponds to the time offset of the present disclosure) to a current time, where the offset value is at least related to a duration for processing the RRC message.

In one embodiment, the duration for processing the RRC message may be converted into a statistical unit of the slot. For example, the conversion process is to divide the duration by the length occupied by the slot (NR slot length), thereby obtaining a duration in the unit of the slot. The length occupied by the slot is related to numerology of the activated SCell.

In one embodiment, the starting of the SCell inactivity timer includes start and restart.

In one embodiment, the current time is a slot n for receiving a direct SCell activation message (the RRC message of the present disclosure).

As an embodiment, the slot n may be the last slot for receiving a PDSCH transmission carrying the RRC message.

In one embodiment, the direct SCell activation method includes:
a first method, where the first method is direct SCell activation at SCell addition (i.e., activating the SCell directly using configuration information in the RRC message);
a second method, where the second method is direct SCell activation at handover (i.e., activating the SCell directly using configuration information in the handover message); and
a third method, where the third method is direct SCell activation at RRC resume (i.e., activating the SCell directly using configuration information in the RRC resume message);

In one embodiment, the first offset value may be related to the duration for processing the RRC message. For example, the duration for processing the RRC message includes a processing delay duration (corresponding to the first processing duration) for receiving the RRC message.

In one embodiment, the corresponding first processing duration may be a value defined by a protocol.

In one embodiment, processing delay duration for the RRC message may be defined separately for the first method, the second method, and the third method. In other words, the processing delay duration for the RRC message that corresponds to the first method, the second method, and the third method may be configured to be the same or different, achieving flexible duration configurations.

In one embodiment, for the first method and the third method, the first offset value is at least related to the duration for processing the RRC message. For example, the duration for processing the RRC message includes a processing delay (the first processing duration) for receiving the RRC message and a delay (the second processing duration) for feeding back the response message of the RRC message to a network.

In one embodiment, the processing delay (corresponding to the first processing duration of the present disclosure) for receiving the RRC message is T_{RRC_Process}, where T_{RRC_Process} is an RRC processing delay defined in clause 12 of technical specification 38.331 (TS 38.331).

In one embodiment, the delay (corresponding to the second processing duration of the present disclosure) for feeding back the response message of the RRC message to the network is a time interval from the processing delay for receiving the RRC message until sending the response message of the RRC message. Here, the time interval may be a duration from time X until sending the response message of the RRC message, where X=slot n+T_{RRC_Process}/NR slot length, slot n is the last slot for receiving the PDSCH transmission carrying the RRC message, T_{RRC_Process} is a duration for processing the received RRC message, and NR slot length is a slot duration for NR.

In one embodiment, for the first method, the received RRC message is the RRC connection reconfiguration message, and the RRC response message (the response message of the RRC message in the present disclosure) fed back to the network is the RRC connection reconfiguration complete message.

In one embodiment, for the third method, the received RRC message is the RRC connection resume message, and the RRC response message fed back to the network is the RRC connection resume complete message.

In one embodiment, for the second method, the offset value is at least related to the duration for processing the RRC message. For example, the duration for processing the RRC message includes a processing delay for receiving the RRC message (the first processing duration), a handover interruption duration (the third processing duration), and a duration for processing the TA (the fourth processing duration).

In one embodiment, the processing delay for receiving the RRC message (corresponding to the first processing duration in the present disclosure) is T_{RRC_Process}, where T_{RRC_Process} is an RRC processing delay defined in clause 12 of TS 38.331.

In one embodiment, the handover interruption duration (corresponding to the third processing duration in the present disclosure) is Tᵢₙₜₑᵣᵣᵤₚₜ, where Tᵢₙₜₑᵣᵣᵤₚₜ is interruption time during a handover procedure as specified in clause 6.1.1.

In one embodiment, the duration (corresponding to the fourth processing duration in the present disclosure) for processing the TA includes a duration from the statistics completion of the handover interruption duration to the reception of the valid TA command and the duration for applying the TA.

For example, the duration from the end of the handover interruption duration to the reception of the valid TA command may be a duration from time Y until receiving the valid TA command, where Y=slot n+(T_{RRC_Process}+Tᵢₙₜₑᵣᵣᵤₚₜ)/NR slot length, slot n is the last slot for receiving the PDSCH transmission carrying the RRC message, T_{RRC_Process} is a duration for processing the received RRC message, and NR slot length is a slot duration for NR. The TA command is used for a target primary cell.

For example, the delay for applying the received TA to an uplink transmission of the target Pcell is greater than or equal to (k+1) slots, where k is defined in clause 4.2 of TS 38.213.

In one embodiment, in a case where the terminal receives a direct SCell activation command [1X, TS 38.331] for a secondary cell ending at the slot n, the terminal performs corresponding actions in [11, TS 38.321] according to the minimum requirement defined in [10, TS 38.133] except for the following:

in one embodiment, for actions of the SCellDeactivationTimer associated with the secondary cell [11, TS 38.321], the UE applies the actions in slot n+(T_{RRC_Process}+T₁)/NR slot length at SCell addition or RRC resume, in accordance with the definition in [10, TS 38.133].

In one embodiment, for actions of the SCellDeactivationTimer associated with the secondary cell [11, TS 38.321], the UE applies the actions in slot n+(T_{RRC_Process}+T₁+Tₓ)/NR slot length at SCell addition or RRC resume, in accordance with the definition in [10, TS 38.133].

In one embodiment, for actions of the SCellDeactivationTimer associated with the secondary cell [11, TS 38.321], the UE applies the actions in slot n+(T_{RRC_Process}+T₂+T₃)/NR slot length at handover, in accordance with the definition in [10, TS 38.133].

In one embodiment, in addition to the first processing duration, the second processing duration, the third processing duration, and the fourth processing duration mentioned above, other delay values predefined by the protocol, such as a fifth processing duration, may also be appended.

For example, in the following embodiment, Tₓ is appended as the fifth processing duration.

In one embodiment, for actions of the SCellDeactivationTimer associated with the secondary cell [11, TS 38.321], the UE directly activates the SCell in slot n+(T_{RRC_Process}+T₂+T₃+Tₓ)/NR slot length at handover, in accordance with the definition in [10, TS 38.133].

In one embodiment, a second offset value may also be appended based on the first offset value at least related to the duration for processing the RRC message.

For example, in the following embodiment, t milliseconds (e.g., 1 ms) are appended as the second additional offset value.

In one embodiment, for actions of the SCellDeactivationTimer associated with the secondary cell [11, TS 38.321], the UE directly activates the SCell in slot n+1+(T_{RRC_Process}+T₂+T₃+Tₓ)/NR slot length at handover, in accordance with the definition in [10, TS 38.133].

Additionally, under the direct SCell activation method, the starting time of the SCell deactivation timer is determined by adding one offset value (a first offset value corresponding to the time offset of the present disclosure) to a current time, where a method for determining the offset value at least related to the duration for processing the RRC message may be applied based on at least one of a terminal capability or a network capability.

In one embodiment, the operation may be performed, in a case where the terminal has the capability to start or restart the SCell deactivation timer according to the direct SCell activation method. For a terminal without the capability, the time for starting or restarting the SCell deactivation timer may be determined based on its own implementation.

In one embodiment, the terminal may start or restart the SCell inactivation timer in accordance with the method, in a case where the network has issued the capability of starting or restarting the SCell deactivation timer according to the direct SCell activation method. The time for starting or restarting the SCell inactivation timer may be determined based on its own implementation, in a case where the terminal enters a cell that does not support the capability.

In one embodiment, the operation may be performed, in a case where the two conditions are met, which are the network has issued the capability of starting or restarting the SCell deactivation timer according to the direct SCell activation method and the terminal has the capability to start or restart the SCell inactivation timer according to the direct SCell activation method. Otherwise, the time for starting or restarting the SCell inactivation timer by the terminal may be determined based on its own implementation.

It is to be noted that in certain scenarios, in the present disclosure, the SCell deactivation timer may also be referred to as a SCell inactivation timer.

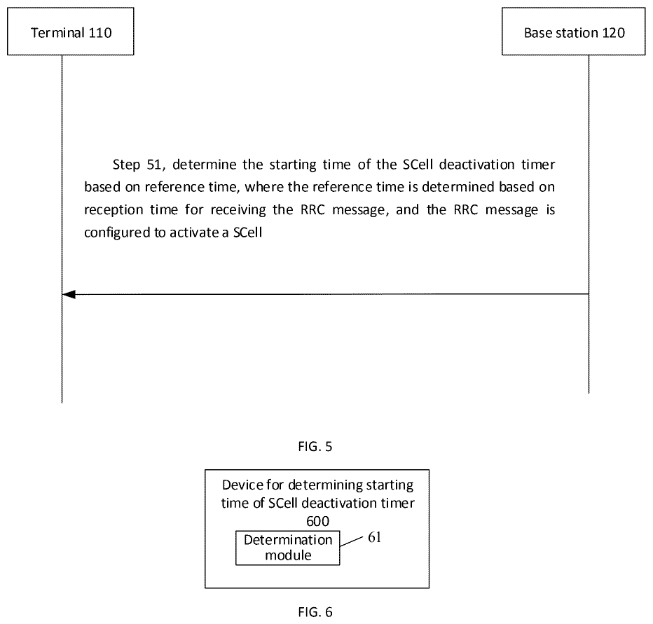

As shown in FIG. 6, the embodiment of the present disclosure provides a device 600 for determining the starting time of the SCell deactivation timer. The device 600 includes:

a determination module 61 configured to determine the starting time of the SCell deactivation timer based on reference time and a time offset; where the reference time is determined based on reception time for receiving a radio resource control (RRC) message, and the RRC message is configured to activate a SCell.

In one embodiment, the determination module 61 is further configured to determine the RRC message as one of the following:
an RRC connection reconfiguration message received during the SCell addition procedure;
an RRC handover message received during the cell handover procedure; and
an RRC connection resume message received during the RRC connection resume procedure.

In one embodiment, the determination module 61 is further configured to:
determine the time offset based on a processing time for processing the RRC message.

In one embodiment, in a case where the RRC message is the RRC connection reconfiguration message or the RRC connection resume message, the determination module 61 is further configured to determine:
a first processing duration, where the first processing duration is a processing delay for receiving the RRC message; and
a second processing duration, where the second processing duration is a duration from receiving the RRC message to sending a response message of the RRC message to an access network device.

In one embodiment, in a case where the RRC message is the RRC handover message, the determination module 61 is further configured to determine:
a first processing duration, where the first processing duration is a processing delay for receiving the RRC message;
a third processing duration, where the third processing duration is a handover interruption duration; and
a fourth processing duration, where the fourth processing duration is a duration for processing timing advance (TA), where the duration for processing the TA includes: a duration from the end of the handover interruption duration to the reception of a valid TA command and a duration for applying the TA.

In one embodiment, the determination module 61 is further configured to determine that the processing time further includes a fifth processing duration determined based on a predefined communication protocol.

In one embodiment, the determination module 61 is further configured to determine that the processing time is time determined based on a slot.

It is to be noted that those skilled in the art may understand that the methods provided in the embodiments of the present disclosure may be performed independently, or may be performed together in conjunction with some methods in the embodiments of the present disclosure or some methods in the related art.

An embodiment of the present disclosure provides a communication device. The communication device includes:
a processor; and
a memory, configured to store processor-executable instructions;
where the processor is configured to execute the executable instructions to perform the method applied to any embodiment of the present disclosure.

The processor may include various types of storage mediums. The storage mediums are non-transitory computer storage mediums capable of retaining the stored information upon power-off of the communication device.

The processor may be connected to the memory via a bus, etc., and is configured to read an executable program stored in the memory.

An embodiment of the present disclosure further provides a computer storage medium, storing a computer-executable program. The executable program, when executed by a processor, implements the method according to any embodiment of the present disclosure.

As for the device described in the above embodiments, the specific operations performed by each module have been described in detail in the corresponding method embodiments, which are not be further elaborated here.

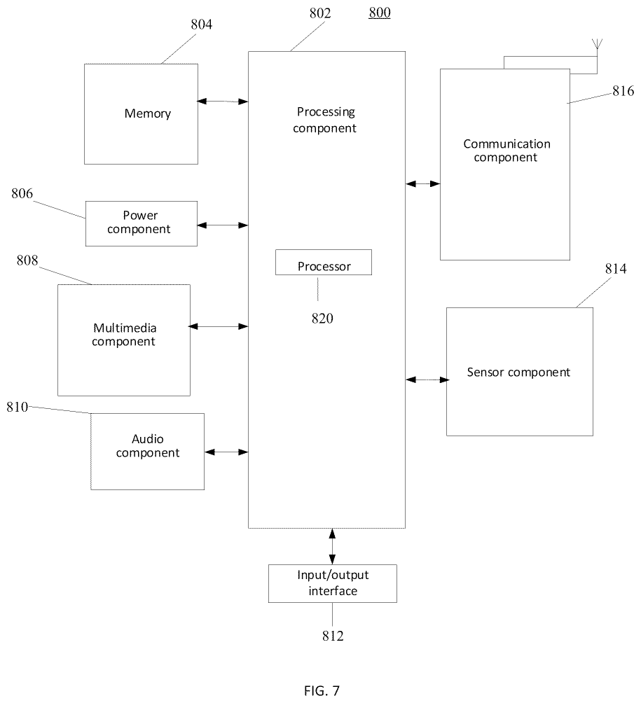

As shown in FIG. 7, an embodiment of the present disclosure provides a structure of a terminal.

Referring to FIG. 7, a terminal 800 is illustrated. The embodiment provides the terminal 800. The terminal may specifically be a mobile phone, a computer, a digital broadcasting terminal, a messaging device, a game console, a tablet device, a medical device, a fitness device, a personal digital assistant, etc.

Referring to FIG. 7, the terminal 800 may include one or more of the following components: a processing component 802, a memory 804, a power component 806, a multimedia component 808, an audio component 810, an input/output (I/O) interface 812, a sensor component 814, and a communication component 816.

The processing component 802 typically controls the overall operation of the terminal 800, such as operations related to display, telephone calls, data communications, camera operations, and recording operations. The processing component 802 may include one or more processors 820 to execute instructions to complete all or part of the steps of the above-mentioned method. Additionally, the processing component 802 may include one or more modules to facilitate interaction between the processing component 802 and other components. For example, the processing component 802 may include a multimedia module to facilitate interaction between the multimedia component 808 and the processing component 802.

The memory 804 is configured to store various types of data to support the operation of the terminal 800. Examples of such data include instructions for any applications or methods operating on the terminal 800, contact data, phonebook data, messages, pictures, videos, etc. The memory 804 may be implemented by any type of volatile or non-volatile memory device or a combination of them, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk.

The power component 806 supplies power to various components of the terminal 800. The power component 806 may include a power management system, one or more power supplies, and other components associated with the generation, management, and distribution of power for the terminal 800.

The multimedia component 808 includes a screen that provides an output interface between the terminal 800 and a user. In some embodiments, the screen may include a liquid crystal display (LCD) and a touch panel (TP). The screen may function as a touch screen to receive input signals from the user, in a case where the screen includes the touch panel. The touch panel includes one or more touch sensors to sense touches, slides, and gestures on the touch panel. The touch sensor is able to not only sense a boundary of a touch or slide action but also detect a duration and pressure associated with the touch or slide operation. In some embodiments, the multimedia component 808 includes a front camera and/or a rear camera. The front camera and/or the rear camera may receive external multimedia data, in a case where the terminal 800 is in an operation mode, such as a shooting mode or a video mode. Each of the front camera and the rear camera may be a fixed optical lens system or have focal length and optical zoom capability.

The audio component 810 is configured to output and/or input an audio signal. For example, the audio component 810 includes a microphone (MIC). The microphone is configured to receive an external audio signal, in a case where the terminal 800 is in an operation mode, such as a call mode, a recording mode, and a voice recognition mode. The received audio signal may be further stored in the memory 804 or transmitted via the communication component 816. In some embodiments, the audio component 810 also includes a speaker configured to output the audio signal.

The I/O interface 812 provides an interface between the processing component 802 and a peripheral interface module. The peripheral interface module may be a keyboard, a click wheel, buttons, etc. These buttons may include, but are not limited to, a home button, volume buttons, a power button, and a lock button.

The sensor component 814 includes one or more sensors configured to provide state assessments of various aspects of the terminal 800. For example, the sensor component 814 may detect an on/off state of the terminal 800, as well as relative positioning of the components, such as a display and a keypad of the terminal 800. The sensor component 814 may also detect changes in the position of the terminal 800 or one component of the terminal 800, the presence or absence of user contact with the terminal 800, the orientation or acceleration/deceleration of the terminal 800, and temperature changes of the terminal 800. The sensor component 814 may include a proximity sensor configured to detect the presence of nearby objects without any physical contact. The sensor component 814 may also include a light sensor, such as a complementary metal-oxide-semiconductor transistor (CMOS) or charge coupled device (CCD) image sensor, for use in imaging applications. In some embodiments, the sensor component 814 may also include an acceleration sensor, a gyroscope sensor, a magnetic sensor, a pressure sensor, or a temperature sensor.

The communication component 816 is configured to facilitate wired or wireless communication between the terminal 800 and other devices. The terminal 800 may access a wireless network based on a communication standard, such as Wi-Fi, 2G, or 3G, or a combination of them. In an example, the communication component 816 receives a broadcast signal or broadcast-related information from an external broadcast management system via a broadcast channel. In an example, the communication component 816 also includes a near field communication (NFC) module to facilitate short-range communication. For example, the NFC module may be implemented based on a radio frequency identification (RFID) technology, an infrared data association (IrDA) technology, an ultra-wideband (UWB) technology, a Bluetooth (BT) technology, and other technologies.

In an example, the terminal 800 may be implemented using one or more application-specific integrated circuits (ASICs), digital signal processors (DSPs), digital signal processing devices (DSPDs), programmable logic devices (PLDs), field-programmable gate arrays (FPGAs), controllers, microcontrollers, microprocessors, or other electronic components to perform the above-mentioned method.

In an example, a non-transitory computer-readable storage medium including instructions is also provided, such as the memory 804 including instructions. The above-mentioned instructions may be executed by the processor 820 of the terminal 800 to complete the above-mentioned methods. For example, the non-transitory computer-readable storage medium may be a ROM, a random access memory (RAM), a compact disc read-only memory (CD-ROM), a magnetic tape, a floppy disk, an optical data storage device, etc.

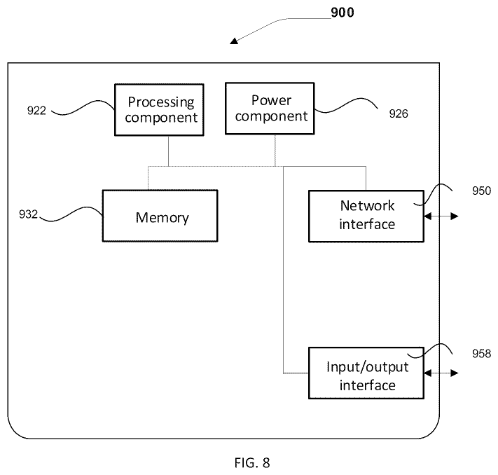

As shown in FIG. 8, an embodiment of the present disclosure provides a structure of a base station. For example, the base station 900 may be provided as a network-side device. Referring to FIG. 8, the base station 900 includes a processing component 922, and further includes one or more processors, and a memory resource represented by a memory 932 for storing instructions executable by the processing component 922, such as an application program. The application program stored in the memory 932 may include one or more modules, each corresponding to a set of instructions. Additionally, the processing component 922 is configured to execute the instructions to perform any of the above-mentioned methods applied to the base station.

As used herein, the term processor may refer to one processor that performs the defined functions or a plurality of processors that collectively perform defined functions, such that the execution of the individual defined functions may be divided amongst such processors.

The base station 900 may further include one power component 926 configured to perform power management of the base station 900, one wired or wireless network interface 950 configured to connect the base station 900 to the network, and one input/output (I/O) interface 958. The base station 900 may be operated based on an operating system stored in the memory 932, such as Windows Server™, Mac OS X™, Unix™, Linux™, FreeBSD™, or the like.

Upon consideration of the specification and practice of the present disclosure, those skilled in the art easily conceive other implementation solutions of the present disclosure. The present disclosure is intended to cover any variations, applications, or adaptations of the present disclosure, which follow the general principles of the present disclosure and include well-known knowledge or customary technical means in the art that are not disclosed in the present disclosure. The specification and the embodiments are merely to be considered as illustrative, and the true scope and spirit of the present disclosure are defined by the claims below.

It is to be understood that the present disclosure is not limited to the exact structures described above and shown in the accompanying drawings, and various modifications and changes may be made without departing from its scope. The scope of the present disclosure is merely limited by the appended claims.

1. A method for determining a starting time of a secondary cell (SCell) deactivation timer, wherein the method is performed by a terminal and comprises:
determining the starting time of the SCell deactivation timer based on a reference time and a time offset,
wherein the reference time is determined based on a reception time for receiving a radio resource control (RRC) message, and the RRC message is configured to activate a SCell.

2. The method according to claim 1, wherein the RRC message is one of the following:
an RRC connection reconfiguration message received during a SCell addition procedure;
an RRC handover message received during a cell handover procedure; and
an RRC connection resume message received during an RRC connection resume procedure.

3. The method according to claim 1, further comprising:
determining the time offset based on a processing time for processing the RRC message.

4. The method according to claim 3, wherein in a case where the RRC message is an RRC connection reconfiguration message or an RRC connection resume message, the processing time comprises:
a first processing duration, wherein the first processing duration is a processing delay for receiving the RRC message; and
a second processing duration, wherein the second processing duration is a duration from receiving the RRC message to sending a response message of the RRC message to an access network device.

5. The method according to claim 3, wherein in a case where the RRC message is an RRC handover message, the processing time comprises:
a first processing duration, wherein the first processing duration is a processing delay for receiving the RRC message;
a third processing duration, wherein the third processing duration is a handover interruption duration; and
a fourth processing duration, wherein the fourth processing duration is a duration for processing a timing advance (TA), wherein the duration for processing the TA comprises: a duration from end of the handover interruption duration to reception of a valid TA command and a duration for applying the TA.

6. The method according to claim 4, wherein the processing time further comprises a fifth processing duration determined based on a predefined communication protocol.

7. The method according to claim 4, wherein the processing time is time determined based on a slot.

8-14. (canceled)

15. A communication device, comprising:
one or more processors; and
a memory configured to store processor-executable instructions; wherein
the processor-executable instructions, when collectively executed by the one or more processors, cause the communication device to:
determine a starting time of a secondary cell (SCell) deactivation timer based on a reference time and a time offset,
wherein the reference time is determined based on a reception time for receiving a radio resource control (RRC) message, and the RRC message is configured to activate a SCell.

16. A non-transitory computer storage medium storing computer-executable instructions, wherein the computer-executable instructions, when executed by a processor, cause the non-transitory computer storage medium to:
determine a starting time of a secondary cell (SCell) deactivation timer based on a reference time and a time offset,
wherein the reference time is determined based on a reception time for receiving a radio resource control (RRC) message, and the RRC message is configured to activate a SCell.

17. The communication device according to claim 15, wherein the RRC message is one of the following:
an RRC connection reconfiguration message received during a SCell addition procedure;
an RRC handover message received during a cell handover procedure; and
an RRC connection resume message received during an RRC connection resume procedure.

18. The communication device according to claim 15, wherein the communication device is further configured to:
determine the time offset based on a processing time for processing the RRC message.

19. The communication device according to claim 18, wherein in a case where the RRC message is an RRC connection reconfiguration message or an RRC connection resume message, the processing time comprises:
a first processing duration, wherein the first processing duration is a processing delay for receiving the RRC message; and
a second processing duration, wherein the second processing duration is a duration from receiving the RRC message to sending a response message of the RRC message to an access network device.

20. The communication device according to claim 18, wherein in a case where the RRC message is an RRC handover message, the processing time comprises:
a first processing duration, wherein the first processing duration is a processing delay for receiving the RRC message;
a third processing duration, wherein the third processing duration is a handover interruption duration; and
a fourth processing duration, wherein the fourth processing duration is a duration for processing a timing advance (TA), wherein the duration for processing the TA comprises: a duration from end of the handover interruption duration to reception of a valid TA command and a duration for applying the TA.

21. The communication device according to claim 19, wherein the processing time further comprises a fifth processing duration determined based on a predefined communication protocol.

22. The communication device according to claim 19, wherein the processing time is time determined based on a slot.

23. The non-transitory computer storage medium according to claim 16, wherein the RRC message is one of the following:
an RRC connection reconfiguration message received during a SCell addition procedure;
an RRC handover message received during a cell handover procedure; and
an RRC connection resume message received during an RRC connection resume procedure.

24. The non-transitory computer storage medium according to claim 16, wherein the non-transitory computer storage medium is further configured to:
determine the time offset based on a processing time for processing the RRC message.

25. The non-transitory computer storage medium according to claim 24, wherein in a case where the RRC message is an RRC connection reconfiguration message or an RRC connection resume message, the processing time comprises:
a first processing duration, wherein the first processing duration is a processing delay for receiving the RRC message; and
a second processing duration, wherein the second processing duration is a duration from receiving the RRC message to sending a response message of the RRC message to an access network device.

26. The non-transitory computer storage medium according to claim 24, wherein in a case where the RRC message is an RRC handover message, the processing time comprises:
a first processing duration, wherein the first processing duration is a processing delay for receiving the RRC message;
a third processing duration, wherein the third processing duration is a handover interruption duration; and
a fourth processing duration, wherein the fourth processing duration is a duration for processing a timing advance (TA), wherein the duration for processing the TA comprises: a duration from end of the handover interruption duration to reception of a valid TA command and a duration for applying the TA.

27. The non-transitory computer storage medium according to claim 25, wherein the processing time further comprises a fifth processing duration determined based on a predefined communication protocol.
